(19) United States
(12) Patent Application Publication
(10) Pub. No.: US 2010/0321323 A1
(43) Pub. Date: Dec. 23, 2010

(54) METHOD AND APPARATUS FOR REDUCING MULTI-TOUCH INPUT ERROR IN PORTABLE COMMUNICATION SYSTEM

(75) Inventor: Dong-Sub Kim, Hwaseong-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/818,598

(22) Filed: Jun. 18, 2010

(30) Foreign Application Priority Data
Jun. 19, 2009 (KR) 10-2009-0054782

(51) Int. Cl. G06F 3/041; G06F 3/048

(52) U.S. Cl. 345/173; 715/810

(57) ABSTRACT

An apparatus and method for correcting a touch input error of a portable terminal are provided. The apparatus includes an icon position selector for arranging only one icon in one cell in a touch screen panel divided into a plurality of cells. Accordingly, the occurrence of a touch input error is reduced.

### PRIORITY

This application claims the benefit under 35 U.S.C. §119(a) of a Korean patent application filed in the Korean Intellectual Property Office on Jun. 19, 2009 and assigned Serial No 10-2009-0054782, the entire disclosure of which is hereby incorporated by reference.

### BACKGROUND OF THE INVENTION

1. Field of the Invention

The present invention relates to an apparatus and method for correcting a touch input error of a portable terminal. More particularly, the present invention relates to an apparatus and method for recognizing a touch input coordinate of a middle position when a user of a portable terminal employing a multi-touch enabled touch screen panel simultaneously touches adjacent icons or two or more icons existing in the same cell.

2. Description of the Related Art

Recently, portable terminals have been widely used due to convenience of portability. To meet customer demands, service providers (or terminal manufacturers) have competitively developed portable terminals with more convenient functions.

For example, a portable terminal provides various functions such as phonebooks, games, schedulers, short message services, multimedia message services, broadcast message services, Internet services, E-mails, wake-up calls, Moving Picture Experts Group (MPEG) Layer 3 (MP3) players, digital cameras, and the like.

Additionally, with the development of a touch screen-type portable terminal for inputting data by touch input or a stylus pen, a user can write text or draw a line on the portable terminal.

In the touch screen-type portable terminal, a touch screen panel may process a user's touch input corresponding to a coordinate at which the touch input is generated. However, when a plurality of points of a coordinate are simultaneously touched, the touch input cannot be recognized. Therefore, the touch input should be sequentially performed. For example, when the user intends to write a character message by using the portable terminal, the user writes the character message by continuously touching characters of the touch screen. In this case, if touch inputs are simultaneously performed on two different characters, any one of the characters may not be input, which leads to an input error.

To solve the aforementioned problem, the portable terminal may employ a multi-touch input enabled touch screen panel. However, when performing a multi-touch operation, a coordinate of a middle position in the multi-touch input enabled touch screen panel is recognized in which a plurality of points are simultaneously touched (i.e., in a case of touching a plurality of icons existing in the same cell).

Therefore, a need exists for an apparatus and method for reducing an input touch error generated when multi-touch input is performed in a portable terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for decreasing a touch input error of a portable terminal.

Another aspect of the present invention is to provide an apparatus and method for controlling icon arrangement and icon movement to decrease a multi-touch input error in a portable terminal.

A further aspect of the present invention is to provide an apparatus and method for decreasing a touch input error by dividing a touch screen panel into a plurality of cells and by preventing two or more icons from being arranged in one cell in a portable terminal.

In accordance with an aspect of the present invention, an apparatus for reducing a multi-touch input error in a portable terminal is provided. The apparatus includes an icon position selector for arranging only one icon in one cell in a touch screen panel divided into a plurality of cells.

In accordance with another aspect of the present invention, a method of reducing a multi-touch input error in a portable terminal is provided. The method includes arranging only one icon in one cell in a touch screen panel divided into a plurality of cells.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a structure of a portable terminal according to an exemplary embodiment of the present invention;

FIG. 2A illustrates a touch screen panel divided into a plurality of cells in a portable terminal according to an exemplary embodiment of the present invention;

FIG. 2B illustrates an icon arrangement process for reducing a multi-touch input error in a portable terminal according to an exemplary embodiment of the present invention;

FIG. 3 is a flowchart illustrating a process of avoiding an erroneous operation resulting from a multi-touch operation in a portable terminal according to an exemplary embodiment of the present invention;

FIG. 4 is a flowchart illustrating an icon arrangement process of a portable terminal according to an exemplary embodiment of the present invention;

FIG. 5A illustrates a screen of a portable terminal according to an exemplary embodiment of the present invention;

FIG. 5B illustrates an icon movement process of a portable terminal according to an exemplary embodiment of the present invention; and

FIG. 5C illustrates a screen for rearranging a location of a moved icon based on a location of a nearby icon in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for decreasing a touch input error resulting from a multi-touch operation in which a plurality of points of a coordinate are simultaneously touched, by dividing a touch screen panel into a plurality of cells and by preventing two or more icons from being arranged on one cell in a portable terminal. The portable terminal may be a portable terminal employing a multi-Resistive (R) type touch screen panel enabling simultaneous touch inputs at a plurality of points of a coordinate.

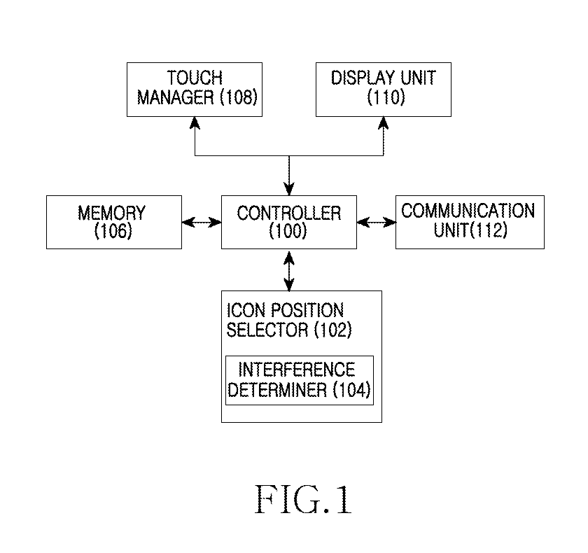

FIG. 1 is a block diagram illustrating a structure of a portable terminal according to an exemplary embodiment of the present invention.

Referring to FIG. 1, the portable terminal includes a controller 100, an icon position selector 102, a memory 106, a touch manager 108, a display unit 110, and a communication unit 112. The icon position selector 102 may include an interference determiner 104.

The controller 100 provides overall control to the portable terminal. For example, the controller 100 processes and controls voice telephony and data communication. In addition, the controller 100 performs an operation for avoiding a touch input error caused by touch inputs simultaneously performed by a user (i.e., an input of touching a plurality of icons existing in the same cell). To perform the aforementioned operation, the controller 100 divides a touch screen panel into a plurality of cells, and then allows only one icon to be arranged in one cell. If the user moves an icon by using the aforementioned technique, the controller 100 determines whether a different icon is located in a cell at a location to which the icon is moved. If the different icon is located in the cell, the controller 100 rearranges the icon to another cell in which no icon is located.

If the icon movement performed by the user of the portable terminal is determined under the instruction of the controller 100, the icon position selector 102 determines whether interference occurs at the location at which the icon is intended to be moved by the user due to a nearby icon. In this case, interference caused by the nearby icon implies that a touch input error occurs since a plurality of icons are located in one cell.

If it is determined that the icon is moved to the location at which interference will occur due to the nearby icon, the icon position selector 102 rearranges the location of the icon to avoid interference from the nearby icon. In this case, the icon position selector 102 rearranges the icon to a location where interference determined by the interference determiner 104 does not occur.

Under the instruction of the controller 100, the interference determiner 104 determines a cell in which interference does not occur with a cell at which the icon is located. That is, when the icon is moved by the user, the interference determiner 104 determines a cell at which no icon is located among cells located near a cell to which the icon is moved.

The memory 106 includes a Read Only Memory (ROM), a Random Access Memory (RAM), a flash ROM, and the like. The ROM stores a microcode (i.e., code) of a program, by which the controller 100 and the icon position selector 102 are processed and controlled, and a variety of reference data.

The RAM is a working memory of the controller 100 and stores temporary data that is generated while programs are performed. The flash ROM stores a variety of rewritable data, such as phonebook entries, outgoing messages, incoming messages, and information such as a touch input point of the user.

The touch manager 108 determines a user's touch input under the instruction of the controller 100 to perform an operation based on the touch input. That is, at the occurrence of the touch input of the user, the touch manager 108 provides the controller 100 with a location of a corresponding point at which the touch input occurs, or determines data corresponding to the location of the corresponding point and outputs the data to the display unit 110.

The display unit 110 displays information such as state information, which is generated while the portable terminal operates, moving pictures, still pictures, and the like. The display unit 110 may be a color Liquid Crystal Display (LCD), an Active Mode Organic Light Emitting Diode (AMOLED), and the like. The display unit 100 may include a touch input device when using a touch input type portable terminal.

The communication unit 112 transmits and receives a Radio Frequency (RF) signal of data that is input and output through an antenna (not illustrated). For example, in a transmitting process, data to be transmitted is subject to a channel-coding process and a spreading process. The data is transformed to an RF signal. In a receiving process, the RF signal is received and transformed to a base-band signal. The base-band signal is subject to a de-spreading process and a channel-decoding process, thereby restoring the data.

Although the function of the icon position selector 102 may be performed by the controller 100 of the portable terminal, elements of the portable terminal are separately constructed for exemplary purposes only. Thus, those ordinary skilled in the art can understand that various modifications can be made within the scope of the present invention. For example, the function of the icon position selector 102 may be processed by the controller 100 in another structure.

An exemplary apparatus for decreasing a touch input error by dividing a touch screen panel into a plurality of cells and by preventing two or more icons from being arranged on one cell in a portable terminal has been described above. Hereinafter, a method for reducing a multi-touch input error of a portable terminal employing a multi-touch input enabled multi-R type touch screen panel will be described by using the aforementioned apparatus according to exemplary embodiments of the present invention.

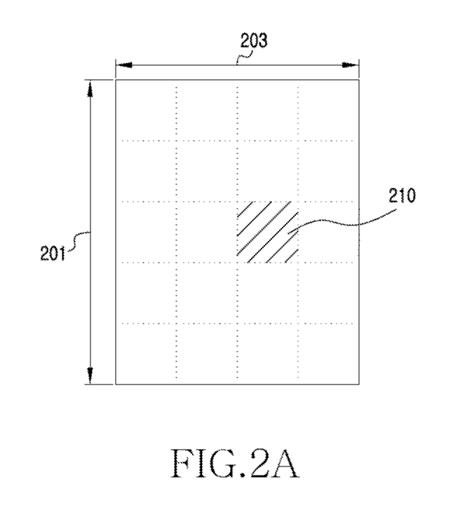

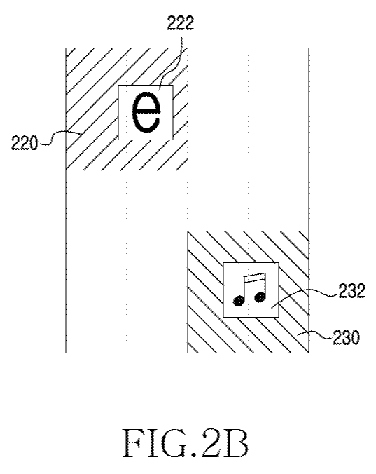

FIGS. 2A and 2B illustrate a touch screen panel of a multi-touch enabled portable terminal according to an exemplary embodiment of the present invention.

FIG. 2A illustrates a touch screen panel divided into a plurality of cells in a portable terminal according to an exemplary embodiment of the present invention. In this case, the touch screen panel includes a multi-R type touch screen panel enabling simultaneous touch inputs at a plurality of points of a coordinate.

Referring to FIG. 2A, the touch screen panel of the portable terminal includes a plurality of cells divided by a specific size in a widthwise direction 203 and a lengthwise direction 201.

In this case, the portable terminal of the present invention prevents two or more icons from being arranged in one cell 210. Thus an erroneous operation (e.g., a problem of recognizing a coordinate of a middle position of the two icons when two icons are touched) that occurs when a plurality of icons are simultaneously touched in the multi-touch enabled portable terminal (i.e., a portable terminal employing a multi-R type touch screen panel) according to the related art may be avoided.

FIG. 2B illustrates an icon arrangement process for reducing a multi-touch input error in a portable terminal according to an exemplary embodiment of the present invention.

Referring to FIG. 2B, the portable terminal prevents a plurality of icons from being arranged in a cell where an icon is located. As illustrated, an icon 222 for an Internet function at least partially occupies four cells 220, and thus another icon cannot be arranged in any of the four cells. Therefore, an icon 232 for a music player is arranged at least partially in four cells 230, wherein the four cells 230 are separated by a specific distance from the four cells 220. Accordingly, different icons do not overlap in each of the cells in which the icon 222 for the Internet and the icon 232 for the music player are respectively located.

The aforementioned technique may prevent icons from overlapping in cells of the portable terminal based on widget movement and icon arrangement.

First, to prevent icons from overlapping by widget movement, the portable terminal divides a touch screen panel into a plurality of cells as described above. In this case, a width and length of the touch screen, information regarding up, down, left, and right sides of an inactive region, information on the widthwise number of cells, lengthwise directions, and the like, are pre-stored in the portable terminal.

If a user moves a new widget to a region overlapping with a previously output widget when the widget is moved in the portable terminal, the portable terminal allows the newly moved widget to be located in another cell in order to avoid an erroneous operation that occurs when the new widget is located in a cell of the previously output widget.

Further, to prevent icons from overlapping by icon arrangement, the portable terminal prevents different icons from being located in the same cell when the icons are arranged, thereby avoiding an erroneous operation which may occur when a plurality of icons are arranged in the same cell.

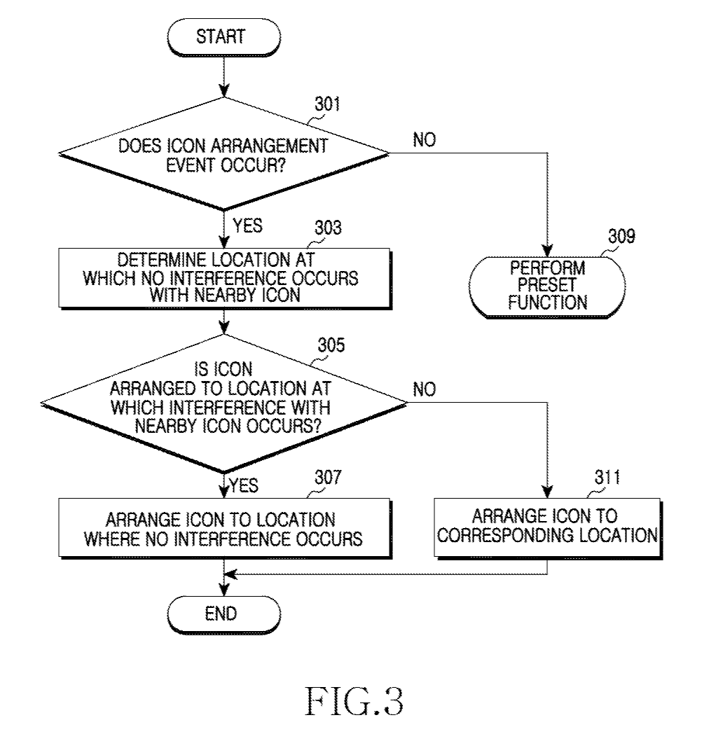

FIG. 3 is a flowchart illustrating a process of avoiding an erroneous operation resulting from a multi-touch operation in a portable terminal according to an exemplary embodiment of the present invention.

Referring to FIG. 3, the portable terminal determines whether an icon arrangement event occurs in step 301. In this case, the icon arrangement event implies icon movement performed by the user or an event of outputting a plurality of icons provided in the portable terminal.

If it is determined in step 301 that the icon arrangement event does not occur, the portable terminal performs a preset function (e.g., a standby mode), in step 309.

If it is determined in step 301 that the icon arrangement event occurs, the portable terminal determines a location at which interference does not occur with a nearby icon in step 303. In a case of using a portable terminal according to the related art, when two or more icons are simultaneously touched, a problem exists in that a coordinate of a middle position is recognized in a multi-touch screen panel. To address this problem, in an exemplary implementation, the touch screen panel is divided into a plurality of cells so that only one icon is arranged in one cell. In this case, with respect to a cell in which an icon is located, a location of another cell in which no icon is located is referred to as a location at which interference with the nearby icon does not occur.

In step 305, the portable terminal determines whether the icon is arranged in a location at which the interference with the nearby icon occurs.

If it is determined in step 305 that the icon is not arranged in the location at which the interference with the nearby icon occurs, the portable terminal determines that interference will not occur since no icon exists in the location in step 311, and thus arranges the icon to that location.

If it is determined in step 305 that the icon is arranged to the location where the interference with the nearby icon occurs, the portable terminal arranges the icon to a location at which interference does not occur between icons in step 307.

In this case, the portable terminal arranges the icon to the location determined in step 303 at which interference does not occur with the nearby icon, i.e., a neighboring cell not overlapping with a cell in which another icon is located, to prevent an erroneous operation which occurs when a multi-touch operation is performed.

Thereafter, the portable terminal terminates the process.

FIG. 4 is a flowchart illustrating an icon arrangement process of a portable terminal according to an exemplary embodiment of the present invention.

Referring to FIG. 4, the portable terminal determines whether icon movement occurs in step 401. The icon movement occurs when a user moves an icon currently being output to another location and when moving any one or more widgets to another location in a widget group consisting of a plurality of widgets.

If it is determined in step 401 that the icon movement does not occur, the portable terminal performs a preset function (e.g., a standby mode).

If it is determined in step 401 that the icon movement occurs, in step 403, the portable terminal performs a process of determining whether another icon exists near a coordinate at which the icon moving in step 401 is to be located.

If it is determined in step 403 that another icon does not exist near the coordinate at which the moving icon is to be located, the portable terminal arranges the moving icon to that location in step 413.

If it is determined in step 403 that another icon exists near the coordinate at which the moving icon is to be located, the portable terminal performs a process of determining a range in which no interference occurs with nearby icons in step 405. In this case, the portable terminal divides a touch screen panel into a plurality of cells. If one icon is located in each cell, the portable terminal may determine that no interference occurs. Accordingly, the portable terminal may determine the range in which interference does not occur with a nearby icon to a location separated by a specific distance from a cell in which an icon is located.

In step 407, the portable terminal determines whether the moving icon in step 401 is moved to a location at which interference occurs.

If it is determined in step 407 that the moving icon is moved to a location at which interference does not occur, the portable terminal arranges the moving icon to that location in step 413.

If it is determined in step 407 that the moving icon is moved to a location at which interference occurs, the portable terminal arranges the icon to a location at which interference does not occur with a nearby icon in step 409.

In this case, to prevent interference occurrence between icons, the portable terminal does not arrange a plurality of icons in one cell. To reduce the probability of occurrence of an erroneous operation by moving a specific icon to a neighboring cell of a cell in which an existing icon is located or by increasing a distance between icons, the icon may be moved to a neighboring cell separated by a distance of one or more cells.

Thereafter, the portable terminal terminates the process.

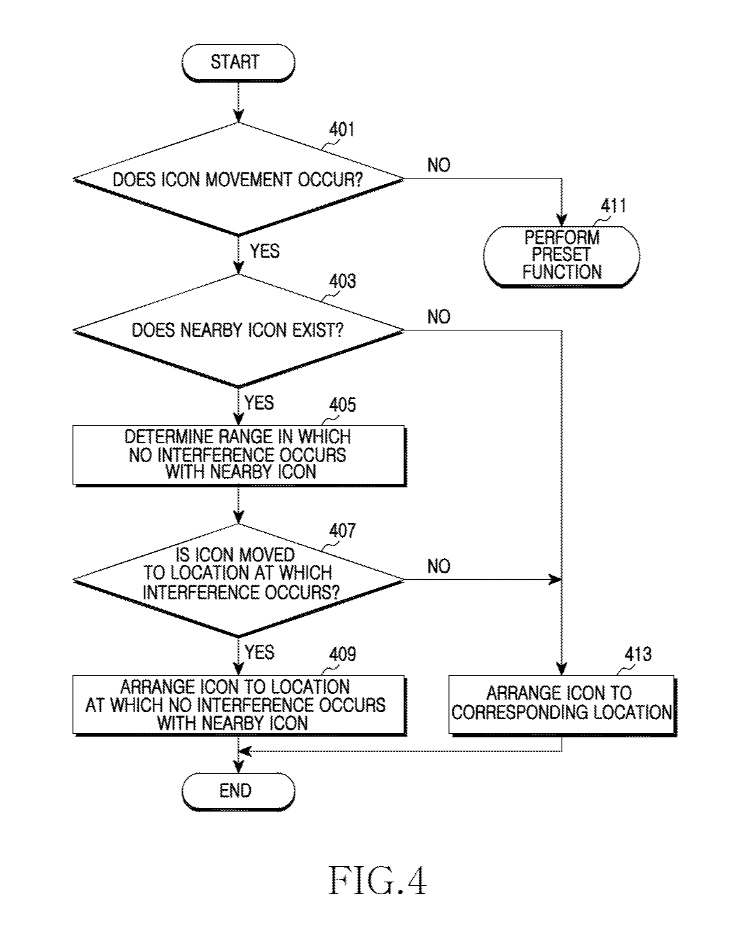

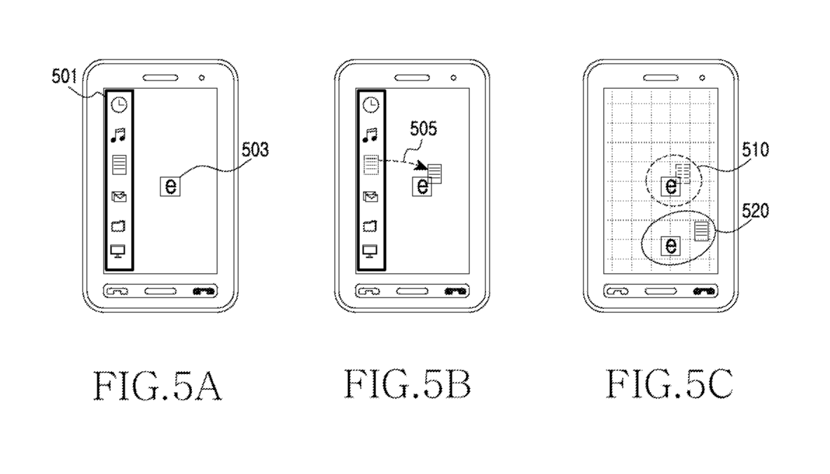

FIGS. 5A-5C illustrate an icon arrangement process of a portable terminal according to an exemplary embodiment of the present invention.

FIG. 5A illustrates a screen of a portable terminal according to an exemplary embodiment of the present invention.

Referring to FIG. 5A, the portable terminal allows a touch screen panel to output a widget group 501 consisting of a plurality of widgets and a first icon 503 which is moved from the widget group 501.

FIG. 5B illustrates an icon movement process of a portable terminal according to an exemplary embodiment of the present invention.

Referring to FIG. 5B, a user of the portable terminal moves the second icon (indicated by 505) in a state in which the first icon has been selected and located as illustrated in FIG. 5A.

In this case, the user of the portable terminal moves the second icon to a location near the first icon.

If the aforementioned situation occurs in a portable terminal according to the related art, the two icons are output in an overlapping manner and thus a user touch cannot be correctly recognized. To address this problem, an exemplary operation of rearranging a location of a moved icon in a portable terminal is performed. The operation is described in more detail below with reference to FIG. 5C.

FIG. 5C illustrates a screen for rearranging a location of a moved icon based on a location of a nearby icon in a portable terminal according to an exemplary embodiment of the present invention.

Referring to FIG. 5C, when a user of the portable terminal intends to move the second icon to a location near the first icon output as described above, the two icons are output in an overlapping manner (indicated by 510) in a portable terminal according to the related art, and thus a user touch cannot be correctly recognized.

To address this problem, the present invention divides a touch screen panel of the portable terminal into a plurality of cells, and then arranges the icon to another cell (indicated by 520) without arranging the icon in the cell in which a previously output icon is located.

In this case, the portable terminal may arrange the icons by separating them by a distance of at least one cell to increase a touch recognition rate.

According to exemplary embodiments of the present invention, a portable terminal divides a touch screen panel into a plurality of cells, and prevents two or more icons from being arranged in one cell (i.e., only one icon is arranged in one cell). Therefore, an error resulting from a multi-touch operation can be avoided when a plurality of points of a coordinate are simultaneously touched in the portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for reducing a multi-touch input error in a portable terminal, the apparatus comprising:
an icon position selector for arranging only a first icon in one cell in a touch screen panel divided into a plurality of cells.

2. The apparatus of claim 1, wherein, if a second icon is moved to the cell location of the first icon, the icon position selector rearranges the second icon to a location of a neighboring cell.

3. The apparatus of claim 2, wherein, if interference occurs with the first icon at a location to which the second icon is moved, the icon position selector determines a location of a cell in which interference does not occur and rearranges the second icon to the location of the determined cell.

4. The apparatus of claim 3, wherein the location of the cell in which interference does not occur comprises a location separated by a distance of at least one cell to increase a touch input recognition rate.

5. The apparatus of claim 1, wherein the portable terminal comprises a multi-Resistive (R) type touch screen panel enabling simultaneous touch inputs at a plurality of points of a coordinate.

6. A method for reducing a multi-touch input error in a portable terminal, the method comprising:
arranging only a first icon in one cell in a touch screen panel divided into a plurality of cells.

7. The method of claim 6, further comprising:
if a second icon is moved to the cell location of the first icon, rearranging the second icon to a location of a neighboring cell.

8. The method of claim 7, wherein the rearranging of the second icon to the location of the neighboring cell comprises:
determining whether interference occurs with a third icon at the location of the neighboring cell;
if it is determined that interference occurs at the location of the neighboring cell, determining a location of a cell at which interference does not occur; and
rearranging the second icon to the location of the determined cell.

9. The method of claim 8, wherein the location of the cell at which interference does not occur is a location of a cell separated by a distance of at least one cell to increase a touch input recognition rate.

10. The method of claim 6, wherein the portable terminal comprises a multi-Resistive (R) type touch screen panel enabling simultaneous touch inputs at a plurality of points of a coordinate.

11. A touch panel for reducing a multi-touch input error, the touch panel comprising:
a controller for dividing the touch panel into a plurality of cells; and
an icon position selector for arranging only a first icon in one cell.

12. The touch panel of claim 11, wherein the icon position selector rearranges a second icon to a location of a neighboring cell, if the second icon is moved to the cell location of the first icon.

13. The touch panel of claim 12, further comprising:
an interference determiner for determining whether the second icon is moved to a location at which interference occurs with a third icon.

14. The touch panel of claim 13, wherein, if it is determined that the second icon is moved to a location at which interference occurs with the third icon, the icon position selector rearranges the second icon to a location where interference does not occur.

15. A method for reducing a multi-touch input error in a touch panel, the method comprising:
dividing the touch panel into a plurality of cells; and
arranging only a first icon in one cell in the divided touch panel.

16. The method of claim 15, further comprising:
rearranging a second icon to a first location of a neighboring cell, if the second icon is moved to the cell location of the first icon.

17. The method of claim 16, wherein the rearranging of the second icon comprises:
rearranging the second icon to a second location if the second icon is moved to the first location in which interference occurs with a third icon.

18. A portable terminal comprising:
a controller for arranging only a first icon in one cell in a touch screen panel divided into a plurality of cells.

19. The portable terminal of claim 18, wherein, if a second icon is moved to the cell where the first icon is already located, the controller rearranges the moved second icon to a location of a neighboring cell.

20. The portable terminal of claim 19, wherein, if interference with a third icon exists at a location to which the second icon is moved, the controller determines a location of a cell in which interference does not occur and rearranges the second icon to a location of the determined cell.

21. The portable terminal of claim 20, wherein the location of the cell in which interference does not occur comprises a location separated by a distance of at least one cell to increase a touch input recognition rate.

22. The portable terminal of claim 18, wherein the portable terminal comprises a multi-Resistive (R) type touch screen panel enabling simultaneous touch inputs at a plurality of points of a coordinate.
